(19) United States
(12) Patent Application Publication
(10) Pub. No.: US 2006/0218133 A1
(43) Pub. Date: Sep. 28, 2006

(54) Constructing dynamic multilingual pages in a Web portal

(76) Inventors: Steven Edward Atkin, Austin, TX (US); Shunguo Yan, Austin, TX (US)

Correspondence Address: IBM CORP. (MRN);c/o LAW OFFICE OF MICHAEL R. NICHOLS, 3001 S. HARDIN BLVD., STE. 110, PMB 155, MCKINNEY, TX, 75070-7702, US

(21) Appl. No.: 11/089,393

(22) Filed: Mar. 24, 2005

(51) Int. Cl. G06F 17/30

(52) U.S. Cl. 707/4

(57) ABSTRACT

A method, computer program product, and apparatus for generating multilingual web pages in a portal is disclosed. According to a preferred embodiment, a filter module associated with a web server intercepts an HTTP (Hypertext Transfer Protocol) request for a particular portal page and identifies the sender of the request. Language preferences for the sender are determined and a set of new language-specific HTTP requests are issued to obtain portlet content in each of the preferred languages of the sender. The results of these language-specific requests are then assembled into a multilingual portal page.

### BACKGROUND OF THE INVENTION

1. Technical Field

The present invention relates generally to web portal technology. Specifically, the present invention provides a method, computer program product, and apparatus for creating dynamic multilingual portals from portlets.

2. Description of the Related Art

The portal market is one of the fastest growing markets of computer software. A portal, in the context of a preferred embodiment of the present invention, may be defined as an application that provides a secure, single point of interaction with diverse information, business processes, and people, personalized to a user's needs and responsibilities. A portal, or “Web portal,” is a Web site or service that offers a broad array of resources and services, such as e-mail, forums, search engines, and on-line shopping malls. Portals are typically accessed by a user on the Internet using a software application, such as a Web browser. A Web browser, or “browser,” is a software application used to locate and display Web pages. Two popular browsers are NETSCAPE NAVIGATOR™ and MICROSOFT INTERNET EXPLORER™. Both of these are graphical browsers, which means that they can display graphics as well as text. In addition, most modern browsers can present multimedia information, including sound and video, though they often require plug-ins in order to handle some formats.

The demand for portals drives rapid development of new technologies by different portal vendors in order to place their products in advantageous market positions. Not surprisingly, portals have evolved to their current state from a more primitive beginning. Originally, portals were mainly used as access points to different information sources with content being chosen by the portal operator. Next, portal customization provided users with the ability to choose the content that was displayed on the user's view of the portal using a Web browser. In this phase, the user was able to select information according to the user's interests and retrieve information related to his or her interests more expeditiously. Customized information delivery led to the introduction of business, or corporate, portals. Business portals were introduced to provide intra-business data within an organization.

The ongoing evolution of portals also left its footprint in the architecture of portal products. At first, portal-like products were delivered as pre-packaged applications that could be installed out of the box and included standard applications, which provided the portal functionality. As new applications were needed, vendors extended their products in order to satisfy requirements of the new applications. Due to the use of proprietary designs, portal vendors added exclusive functionality to their portals, tying the success of a portal to the applications that the portal included. This led to the decomposition of monolithic portal structures and the creation of portal frameworks.

Portal products offered today employ architectures whereby the portal itself only implements standard functionality, such as security, authorization, authentication, aggregation, caching, user management, enrollment, rendering, and the like. The portal provides the infrastructure to integrate other application components. A typical embodiment of this type of architecture includes APIs for integrating applications so that applications from different vendors can be used so long as they match the portal product's API. According to current computing jargon, these applications are commonly called “portlets.” Other synonyms for “portlets” in current use in the art include ‘iViews’ (a term utilized by SAP AG of Walldorf, Germany) or ‘web parts’ (a term utilized by Microsoft, Inc. of Redmond, Wash.).

Portlets are components that can be added to portals and are designed to run inside a portal's portlet container. Portlets may provide different functions ranging from simple rendering of static or dynamic content to application functions such as e-mail, electronic calendaring, and the like. Portlets are invoked indirectly via the portal infrastructure and produce content that is suited for aggregation in larger pages.

In some instances, it is desirable to provide content in multiple languages on a single page. For example, a student of a foreign language may wish to display text in his or her native language with the foreign language side-by-side for comparison. Similarly, certain texts that are available in translation are best understood with ready reference to the original languages. For example, many multilateral treaties that are available in multiple languages may be better understood by comparing the different versions of the text. As a further example, biblical scholars typically make reference to the source languages (Hebrew, Aramaic, and Koine Greek) as well as various translations (Latin Vulgate, King James Version, etc.) in their study of the Bible.

A multilingual web page can be created directly as a single page by using Unicode character sets. The Unicode character encoding standard supports many different languages, including non-alphabetic character-based languages, such as Chinese. Alternatively, a multilingual page may be created by utilizing server-side includes (SSIs), such as those provided by JAVA Server Pages (JSP), to insert different web page fragments into a single page. Both of these approaches, however, suffer from the drawback of not being dynamically configurable. Adding, removing, or rearranging the position of language-specific content, in both of these approaches, requires that the source code to the main page be modified.

What is needed, therefore, is a method of providing dynamically configurable multilingual content in a web page. The present invention provides a solution to this and other problems, and offers other advantages over previous solutions.

### SUMMARY

The present invention provides a method, computer program product, and apparatus for generating multilingual web pages in a portal. According to a preferred embodiment, a filter module associated with a web server intercepts an HTTP (Hypertext Transfer Protocol) request for a particular portal page and identifies the sender of the request. Language preferences for the sender are determined and a set of new language-specific HTTP requests are issued to obtain portlet content in each of the preferred languages of the sender. The results of these language-specific requests are then assembled into a multilingual portal page.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram of a web browser displaying a portal composed of portlets in accordance with a preferred embodiment of the present invention;

FIG. 2 is a diagram illustrating the general operation of a preferred embodiment of the present invention;

FIG. 3 is a diagram illustrating details of the HTTP request headers utilized in a preferred embodiment of the present invention;

FIG. 4 is a flowchart representation of a process of assembling a multilingual portal from portlets in accordance with a preferred embodiment of the present invention; and

FIG. 5 is a block diagram of a data processing system in which the processes of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

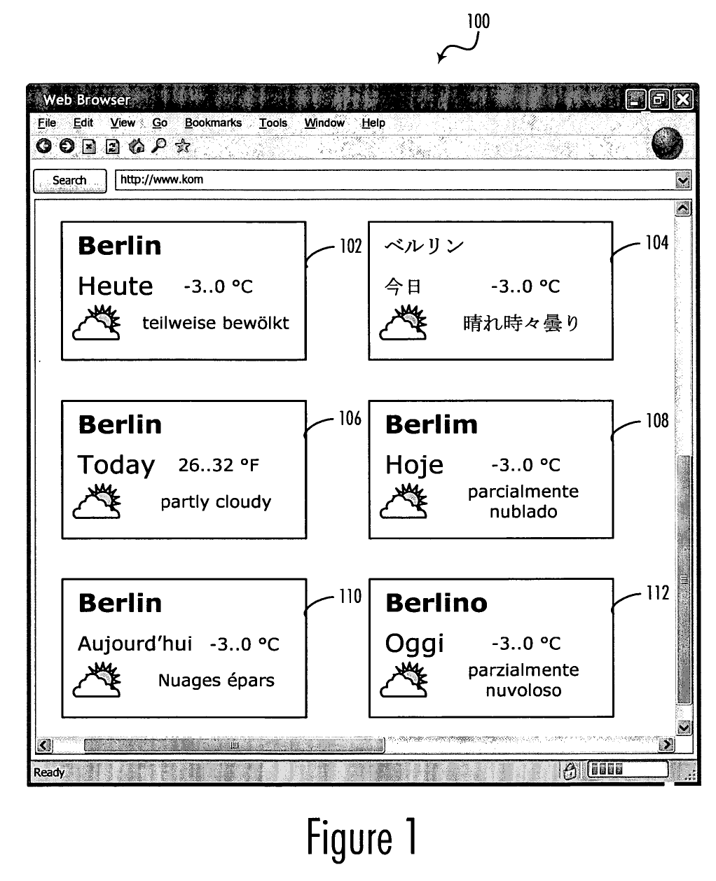

FIG. 1 is a diagram of a Web browser 100 in which a multilingual portal in accordance with the preferred embodiment of the present invention is depicted. As illustrated in FIG. 1, the portal being displayed by Web browser 100 is made up of a number of portlets, each of which is presented in a different language. In the example in FIG. 1, the portlets are used to display a weather report for the city of Berlin in six different languages. Portlets 102, 104, 106, 108, 110, and 112 display the same weather report in German, Japanese, American English, Brazilian Portuguese, French, and Italian, respectively.

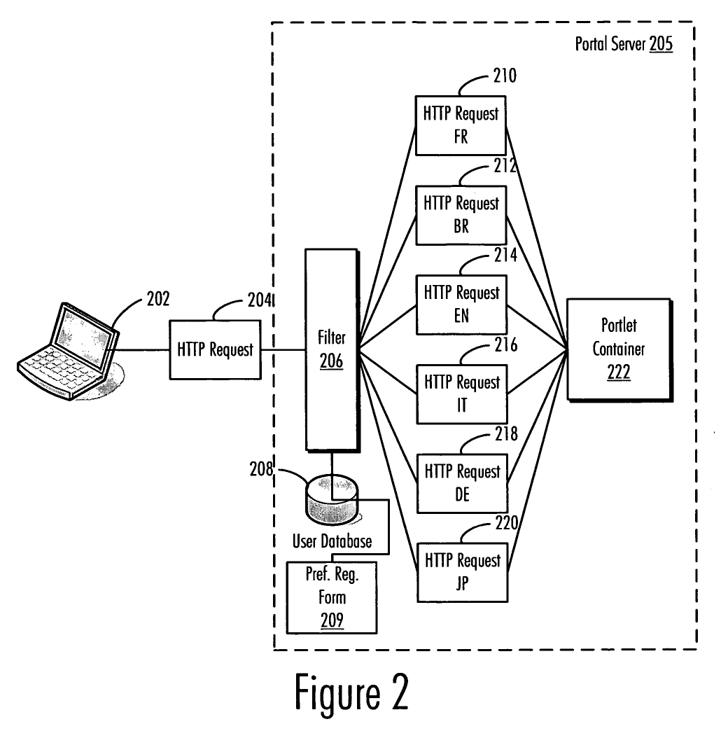

FIG. 2 is a diagram illustrating a process for assembling and presenting a multilingual portal, such as that described in FIG. 2, according to a preferred embodiment of the present invention. A client computer 202 issues a request 204 in Hypertext Transfer Protocol (HTTP) for the multilingual portal page. HTTP (version 1.1) is described in detail in Internet Engineering Task Force (IETF) Request for Comments (RFC) 2616, which is incorporated herein by reference. Request 204 is received by portal server 205, where request 204 is processed by a filter module 206. Filter module 206 is a software module that has the responsibility of ensuring that the multilingual portal page is returned to client computer 202 with content in the desired languages. Filter module 206 accesses a user database 208, which contains information about language preferences of various users of the portal being hosted on portal server 205. Users may utilize preference registration form 209, itself a web page, to input their language preferences into user database 208.

When filter module 206 receives HTTP request 204, filter module 206 first attempts to identify client computer 202. There are a number of different ways of identifying a Web client that are known in the art. For example, a particular Web client might be identified by its Internet protocol (IP) address. Alternatively, portal server 205 might have placed a cookie on client computer 202, which can later be retrieved by web server 205 in order to identify client computer 202 as being the same computer on which the cookie was placed or stored. Once filter module 206 has identified client computer 202, filter module 206 consults user database 208 to determine the language preferences associated with client computer 202. That is, filter 206 determines which languages the user of client computer 202 would like to see displayed on the multilingual portal. In one possible embodiment of the invention, this language preference information may be associated with a Session object (e.g., in the JAVA Servlets Application Programming Interface).

Once the user's preferences have been determined, a series of language-specific HTTP requests 210, 212, 214, 216, 218, and 220 are generated in order to request portlet content in each of the desired languages. In this example, it is assumed that the user's language preferences correspond to the languages displayed in FIG. 1. Thus, HTTP requests 210, 212, 214, 216, 218, and 220 correspond to French, Brazilian Portuguese, American English, Italian, German, and Japanese, respectively. HTTP requests 210, 212, 214, 216, 218, and 220 are forwarded to portlet container 222, which returns the requested content in each of the languages corresponding to each of HTTP requests 210, 212, 214, 216, 218, and 220. The results of each of these requests are returned to filter module 206, where they are assembled into a portal page and returned to client computer 202.

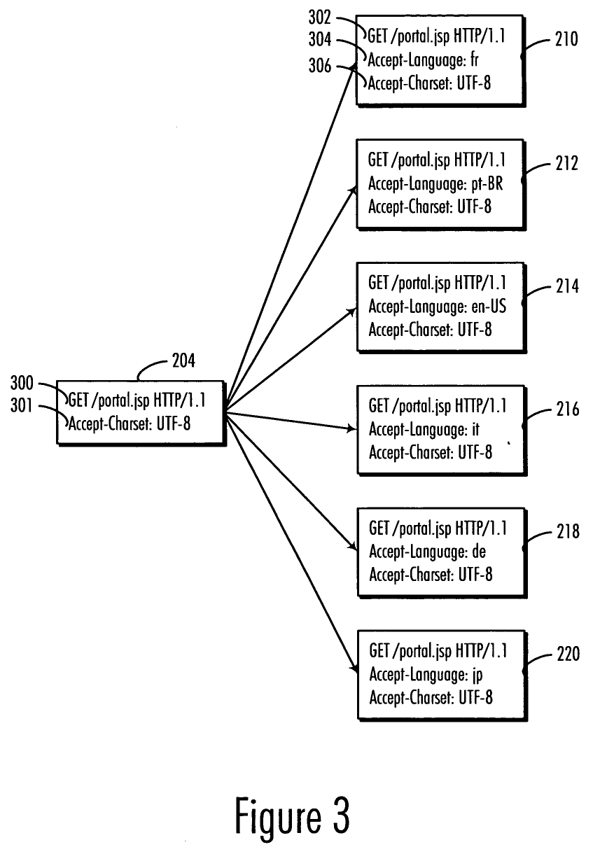

FIG. 3 provides a detailed description of the process of taking an original HTTP request 205 and generating from that original request a set of language-specific HTTP requests 210, 212, 214, 216, 218, and 220 in accordance with the preferred embodiment of the present invention. As shown in FIG. 3, original HTTP request 204 includes an initial header line 300, which identifies the request as an HTTP request and also identifies the document that the HTTP request pertains to, in this case “portal.jsp.” Original HTTP request 204 also includes a header line 301, which indicates the character set in which client computer 202 will accept the results of HTTP request 204. Here, the UTF-8 character encoding is selected. UTF-8 is a byte-encoded version of the Unicode character encoding standard and is described in the Internet Engineering Task Force (IETF) Request for Comments (RFC) 3629. Unicode is an international, multilingual character encoding standard. Unicode can be used to encode alphabetic languages, such as Western European languages that use variants of the Latin alphabet, Russian and other languages using the Cyrillic alphabet, as well as other alphabet-based languages, such as the Semitic languages Hebrew and Arabic. Unicode also supports non-alphabetic character-based languages, such as Chinese and Japanese (Kanji). By accepting the results of original HTTP request 204 in Unicode (via the UTF-8 encoding standard) it is possible for multiple languages (using multiple character sets) to be displayed in a single portal page.

As shown in FIG. 2, filter module 206 takes original HTTP request 204 and generates a set of language-specific HTTP requests 210, 212, 214, 216, 218, and 220 in response to and in accordance with the user's preferences, as stored in user database 208. These language-specific requests are shown in greater detail in FIG. 3. Request 210, which is specific to the French language, like original request 204, starts with an initial “GET” header line 302, which identifies request 210 as an HTTP request and also identifies the document being requested. An additional header line 304 is included to indicate that contents in the French language (denoted by a 2-letter code “fr”) are requested. The codes used to identify languages in HTTP requests are an amalgamation of codes taken from International Standards Organization (ISO) standard 639 (for identifying languages) and ISO standard 3166 (for identifying languages), as described in IETF RFC 3066. A third header line 306 indicates that UTF-8 character encoding is requested. As can be seen in FIG. 3, language-specific HTTP requests are generated for each of the desired languages.

Each of these language-specific HTTP requests, although directed to the same document (in this case “portal.jsp”), each language-specific request has a different “Accept-Language” header. This is a convenient way of indicating that the same informational content is desired in different languages. Ordinarily this technique is used to support different versions (i.e., in different languages) of the same web site on the same web server. In a preferred embodiment of the present invention, however, the technique is used to allow a multilingual portal page to be assembled from different-language versions of the one or more portlets.

One skilled in the art will recognize that although in the example provided, different-language versions of the same portlet are displayed, one may also assemble a portal from several portlets, each in a different language, by applying the teachings of the present invention. For example, in a portal page in accordance with the present invention, a weather portlet may be displayed in English, while a clock portlet is displayed in Chinese, a main content portlet is displayed in French, etc.

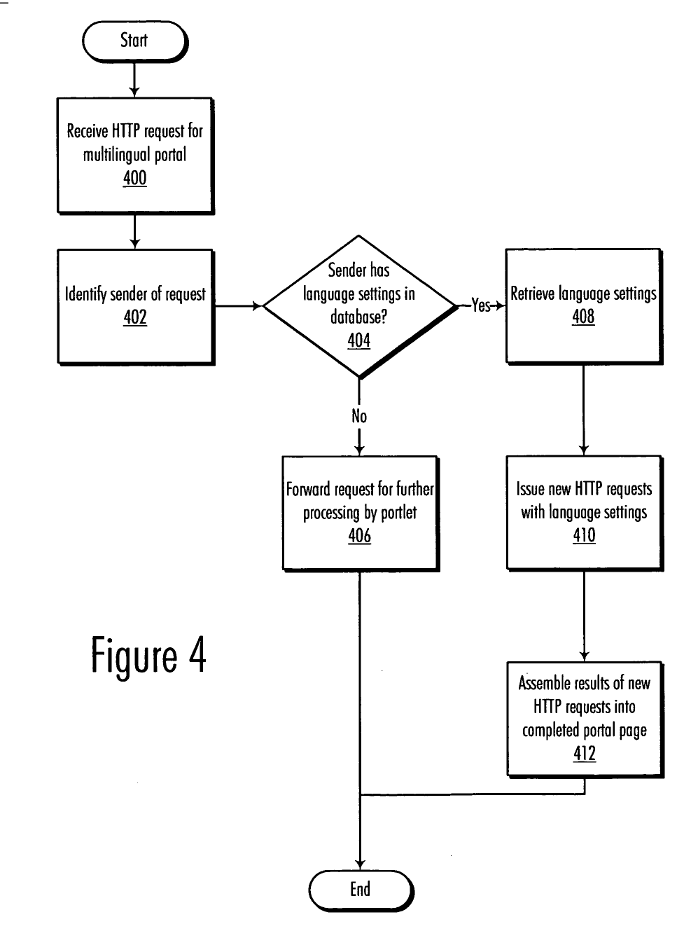

FIG. 4 is a flowchart representation of a process of assembling and presenting a multilingual portal page in accordance with a preferred embodiment of the present invention. First, an HTTP request for a multilingual portal page is received from a client computer (block 400). Next, the sender (i.e., client) of the request is identified, through a cookie or IP address, for example (block 402). Then, a determination is made as to whether the identified sender has language preferences or settings stored in a user database associated with the web server (e.g., user database 208 in FIG. 2) (block 404). If no such settings exist (block 404: no), then the received HTTP request is simply processed as is (block 406), by forwarding the request to portal server 222 (FIG. 2), for example.

If the sender does have language preferences stored in the database (block 404: yes), those language preferences are then retrieved from the database (block 408). New HTTP requests, in which the Accept-Language header is set in accordance with the retrieved language preferences, are generated (block 410). Finally, these new HTTP requests are used to retrieve the desired content in the desired languages, and the results of those new HTTP requests are assembled into a completed multilingual portal page (block 412).

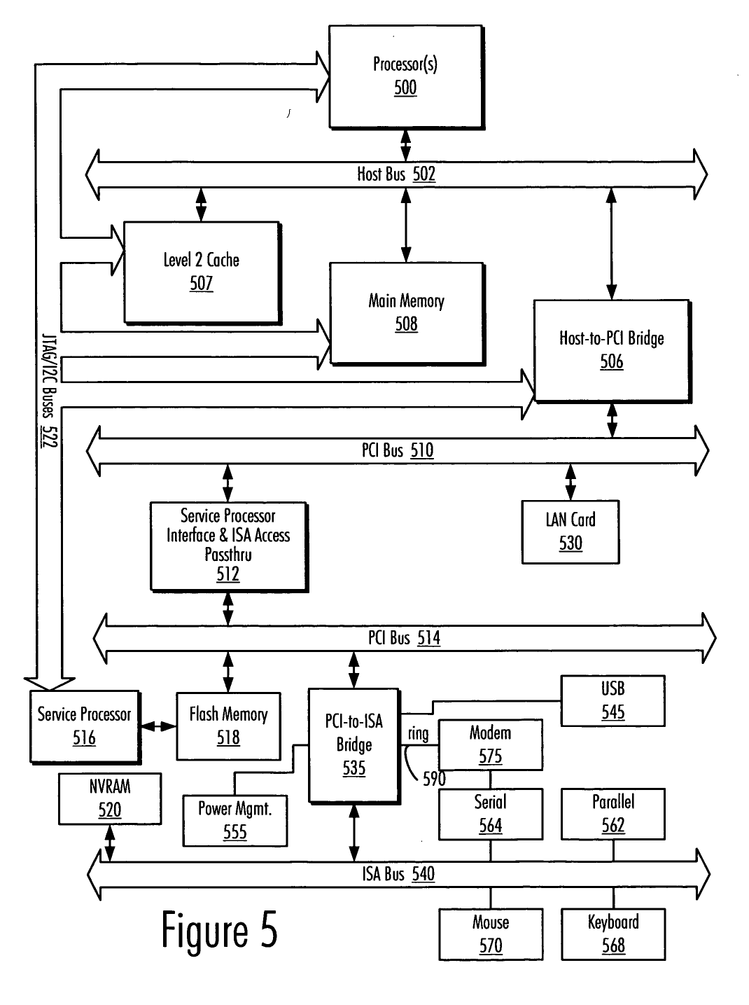

FIG. 5 illustrates an information-handling system or data processing system 501 which is a simplified example of a computer system capable of performing the systems and methods described herein. Computer system 501 includes processor 500 that is coupled to host bus 505. A level two (L2) cache memory 510 is also coupled to the host bus 505. Host-to-PCI bridge 515 is coupled to main memory 520, includes cache memory and main memory control functions, and provides bus control to handle transfers among PCI bus 525, processor 500, L2 cache 510, main memory 520, and host bus 505. PCI bus 525 provides an interface for a variety of devices including, for example, LAN card 530. PCI-to-ISA bridge 535 provides bus control to handle transfers between PCI bus 525 and ISA bus 540, universal serial bus (USB) functionality 545, IDE device functionality 550, power management functionality 555, and can include other functional elements not shown, such as a real-time clock (RTC), DMA control, interrupt support, and system management bus support. Peripheral devices and input/output (I/O) devices can be attached to various interfaces 560 (e.g., parallel interface 562, serial interface 564, infrared (IR) interface 566, keyboard interface 568, mouse interface 570, and fixed disk (FDD) 572 coupled to ISA bus 540. Alternatively, many I/O devices can be accommodated by a super I/O controller (not shown) attached to ISA bus 540.

BIOS 580 is coupled to ISA bus 540 and incorporates the necessary processor executable code for a variety of low-level system functions and system boot functions. BIOS 580 can be stored in any computer readable medium, including magnetic storage media, optical storage media, flash memory, random access memory, read only memory, and communications media conveying signals encoding the instructions (e.g., signals from a network). In order to attach computer system 501 another computer system to copy files over a network, LAN card 530 is coupled to PCI-to-ISA bridge 535. Similarly, to connect computer system 501 to an ISP to connect to the Internet using a telephone line connection, modem 575 is connected to serial port 564 and PCI-to-ISA Bridge 535.

While the computer system described in FIG. 5 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A computer-implemented method comprising:
receiving an original request for a web page from a client;
determining an identification of the client;
determining a plurality of language preferences associated with the identification of the client; and
generating a plurality of language-specific requests from the plurality of language preferences.

2. The method of claim 1, further comprising:
assembling results of the plurality of language-specific requests for presentation to the client in response to the original request.

3. The method of claim 1, wherein the original request specifies a multilingual character encoding.

4. The method of claim 3, wherein the multilingual character encoding is UTF-8.

5. The method of claim 1, wherein each of the language-specific requests contains a request heading specifying an accepted language for that request.

6. The method of claim 1, wherein at least one of the language-specific requests is in Hypertext Transfer Protocol (HTTP).

7. The method of claim 1, wherein the original request is in Hypertext Transfer Protocol (HTTP).

8. A computer program product in a computer-readable medium, comprising functional descriptive material that, when executed by a computer, directs the computer to perform actions that include:
receiving an original request for a web page from a client;
determining an identification of the client;
determining a plurality of language preferences associated with the identification of the client; and
generating a plurality of language-specific requests from the plurality of language preferences.

9. The computer program product of claim 8, comprising additional functional descriptive material that, when executed by a computer, directs the computer to perform actions of:
assembling results of the plurality of language-specific requests for presentation to the client in response to the original request.

10. The computer program product of claim 8, wherein the original request specifies a multilingual character encoding.

11. The computer program product of claim 10, wherein the multilingual character encoding is UTF-8.

12. The computer program product of claim 8, wherein each of the language-specific requests contains a request heading specifying an accepted language for that request.

13. The computer program product of claim 8, wherein at least one of the language-specific requests is in Hypertext Transfer Protocol (HTTP).

14. The computer program product of claim 8, wherein the original request is in Hypertext Transfer Protocol (HTTP).

15. A data processing system comprising:
at least one processor;
data storage associated with the at least one processor; and
a set of instructions in the data storage, wherein the at least one processor executes the set of instructions in the data storage to perform actions of:
receiving an original request for a web page from a client;
determining an identification of the client;
determining a plurality of language preferences associated with the identification of the client; and
generating a plurality of language-specific requests from the plurality of language preferences.

16. The data processing system of claim 15, wherein the at least one processor executes the set of instructions to perform an additional action of:
assembling results of the plurality of language-specific requests for presentation to the client in response to the original request.

17. The data processing system of claim 15, wherein the original request specifies a multilingual character encoding.

18. The data processing system of claim 17, wherein the multilingual character encoding is UTF-8.

19. The data processing system of claim 15, wherein each of the language-specific requests contains a request heading specifying an accepted language for that request.

20. The data processing system of claim 15, wherein at least one of the language-specific requests is in Hypertext Transfer Protocol (HTTP).

21. A system comprising:
a client computer;
a server computer; and
a network allowing communication between the client computer and the server computer,
wherein the client computer transmits a request, through the network, to the server computer;
wherein in response to receiving the request, the server computer generates a plurality of language-specific requests, the language-specific requests corresponding to language preferences associated with the client computer;
wherein the server computer collects and assembles results of the language-specific requests into a portal page; and
wherein the server computer transmits the portal page to the server computer.

22. The system of claim 21, wherein each of the language-specific requests contains a request heading specifying an accepted language for that request.

23. The system of claim 21, wherein the original request specifies a multilingual character encoding.
